(19) United States
(12) Patent Application Publication
(10) Pub. No.: US 2023/0191916 A1
(43) Pub. Date: Jun. 22, 2023

(54) NOVEL ELECTROMAGNETIC PROPULSION AND LEVITATION TECHNOLOGY

(71) Applicant: Micah Skidmore, Sunnyvale, TX (US)

(72) Inventor: Micah Skidmore, Sunnyvale, TX (US)

(21) Appl. No.: 17/556,956

(22) Filed: Dec. 20, 2021

(51) Int. Cl. B60L 13/10; H05H 15/00

(52) U.S. Cl. CPC B60L 13/10; H05H 15/00; H02N 15/02

(57) ABSTRACT

An electromagnetically-propelled vehicle includes a charged-particle accelerator and a magnetic-field generator. Charged particles are accelerated to a velocity v and are directed through the magnetic field B generated by the magnetic-field generator. The interaction between the accelerated charged particles and the magnetic field generates a force between the particles and the magnetic-field generator that may be used to propel or levitate the vehicle.

### BACKGROUND

This invention pertains generally to electromagnetic propulsion and levitation. More specifically, the invention is directed to technology utilizing plasma currents to generate a force on a field-generating plate or coil.

### SUMMARY

In one aspect of the invention, a vehicle with an electromagnetic propulsion/levitation system includes a chassis and a magnetic-field generator attached to the chassis. The magnetic-field generator may be, for example, a permanent magnet or an electromagnet or some combination of the two which generates a magnetic field (B). The vehicle further includes a charged-particle accelerator positioned relative to the magnetic-field generator such that the accelerator, in operation, will provide one or more charged particles with a velocity (v) directing the particle through a magnetic field (B) generated by the generator. The intersection of the particle having a velocity v and the magnetic field B is such that the cross product of the velocity and the magnetic field is not zero (v×B≠0). This positioning of the accelerator relative to the generator enables generation of a force between the particle and the generator (a Lorentz force) that can serve as a propulsive or lifting force on the chassis. The accelerator may include an electromagnetic accelerator (such as a laser or RF/microwave cavity) or an electrostatic generator (such as an electron/ion gun, cascade accelerator, Van de Graaf accelerator, or Pelletron accelerator). One or more electrodes may be used to provide or collect the accelerated particles. The magnetic-field generator may include multiple electromagnet coils that may be independently controlled (e.g., through selective and independent application of current to the individual coils). The magnetic-field generator may be attached to the chassis such that the generator is able to pivot with respect to the chassis and thereby change the direction of B relative to the chassis.

In another aspect of the invention, an electromagnetic propulsion system includes a chassis, a magnetic-field generator attached to the chassis, and a means for providing a stream of charged particles through and, at least in part, other than parallel or anti-parallel to a magnetic field generated by the magnetic-field generator (in operation). The generator may include permanent magnets or electromagnets, which in turn may be comprised of multiple independent coils. The means for providing the stream of charged particles includes an accelerator (e.g., an electrostatic accelerator or an electromagnetic accelerator) positioned relative to the magnetic-field generator so that the stream of accelerated particles runs adjacent to the magnetic-field generator. The proximity and direction of the stream relative to the generator enables generation of a force between the stream and generator, and thereby a force between the stream and the chassis. This force can serve as a propulsive or lifting force on the chassis.

In another aspect of the invention, a method of providing a propulsive or lifting force to a vehicle that includes a magnetic-field generator attached to a chassis includes generating a magnetic field with the generator, accelerating a stream of charged particles, and directing the stream of charged particles through the magnetic field such that at least a portion of the stream is not parallel or antiparallel to the magnetic field. The method may include controlling one or more electrical currents through one or more electromagnet coils as part of generating the magnetic field. The method may include using a permanent magnet to generate the magnetic field. The method may include using a laser beam to accelerate the particles. The light provided by the laser beam may be in the infrared, ultraviolet, or x-ray bands. The method may include changing the orientation of the generator relative to the chassis to change the direction of the magnetic field relative to the chassis in order to change the direction of the propulsive/lifting force. The method may include changing the direction of the particle stream or the direction of the magnetic field in order to change the direction or magnitude of the propulsive/lifting force. The method may include changing the magnitude of the magnetic field or the particle velocity to change the magnitude of the propulsive/lifting force. The method may include changing the particle density in the stream of particles to change the magnitude of the propulsive/lifting force.

In another aspect of the invention, a stream of one or more particles having a magnetic moment may be directed adjacent to a conductive plate to produce a force between the stream and the plate due to the eddy currents induced by the relative motion of the magnetic particles and the conductive plate. In a vehicle including a conductive plate attached to a chassis, a force may be created between a beam of magnetic particles and the chassis by directing the particles adjacent to the plate. This force can serve as a propulsive or lifting force on the chassis. The magnetic particles may be electrically charged and accelerated with a charged-particle accelerator. The magnetic particles may be electrically neutral and provided by an accelerator that utilizes a charged-particle accelerator to initiate a reaction to create moving neutral particles (e.g., a DT neutron generator). The magnitude or direction of this force may be varied by varying one or more of the density of magnetic particles in the stream, the velocity of the particles, the orientation of the plate relative to the chassis, the average orientation of the magnetic moment of the magnetic particles relative to the conductive plate, or the proximity of the particle stream to the conductive plate.

### BRIEF DESCRIPTION OF THE DRAWINGS

These and other features, aspects, and advantages of the present invention will become better understood with reference to the following description, appended claims, and accompanying drawings where:

FIGS. 1A-1C depict an exemplary system for generating a force on a magnetic-field-generating structure by utilizing a particle accelerator to provide a stream of moving charged particles flowing through the magnetic field.

FIG. 2 depicts an exemplary system for generating a force on a conductive plate by utilizing a particle accelerator to provide a stream of charged particles having magnetic moments flowing by the plate.

FIG. 3 depicts a vehicle with an exemplary electromagnetic propulsion system.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

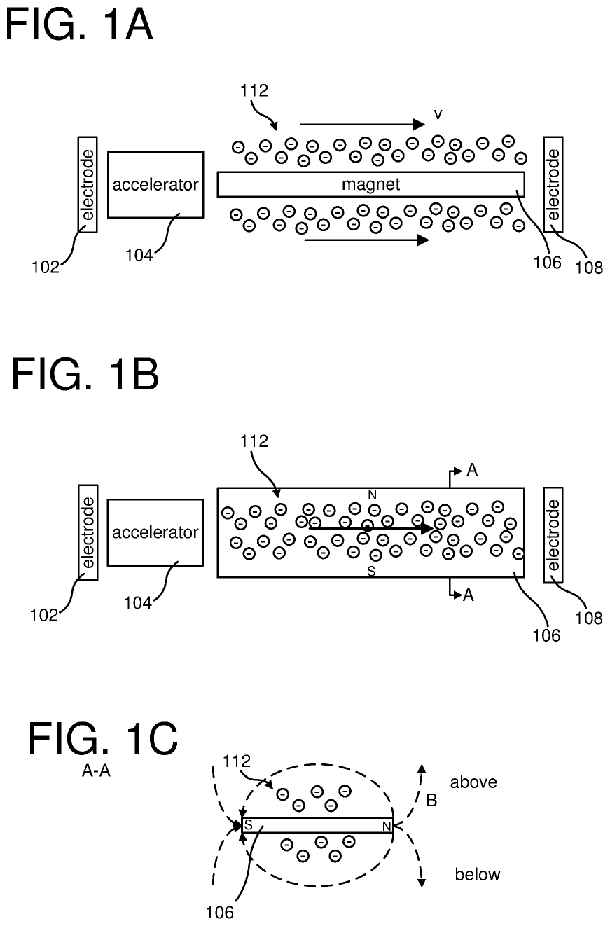

An exemplary embodiment of an electromagnetic propulsion/levitation panel is represented in FIGS. 1A-1C. FIG. 1A shows a side view of a system comprising a source electrode 102, a charged-particle accelerator 104, a magnetic-field generator 106, and a sink electrode 108. FIG. 1B is a top view of the system. FIG. 1C is cross-sectional view of the magnet showing an exemplary magnetic-field configuration. In operation, the source electrode 102 provides charged particles (e.g., electrons/positrons, protons/antiprotons, ions) to the accelerator 104 that accelerates the charged particles to a velocity (v) (perhaps with a spread in velocities from particle to particle). The accelerated particles 112 are directed to the sink electrode 108 along one or more paths adjacent to the magnetic-field generator 106 (the paths are indicated by the arrows in the figures). The magnetic-field generator 106 (e.g., a permanent magnet or an electromagnet) generates a magnetic field (B) with a component that is transverse to the velocity of the charged particles 112 travelling through the field. The motion of the charged particles 112 through the field generates a force (F) between the generator 106 and the particles 112 that varies with the velocity of the particles and the strength of the field (a described with the Lorentz formula: F=q v×B, where q is the charge of the particle). The field B and velocity v can be oriented relative to each other such that the force F tends to draw the generator 106 and particles 112 closer together or to push them farther apart. For instance, a simple field configuration, as depicted in FIGS. 1B and 1C, can be used to force negatively charged particles 112 and the generator 106 toward each other above the generator 106 and apart from each other below the generator 106. The magnetic field shape may be tuned, for example, to optimize the volume of interaction that generates an attractive/repulsive force between the particles and field generator.

In some implementations, the particle speed (magnitude of the velocity v) or magnetic-field strength (magnitude of field B) may be varied to vary the magnitude of the force F. For example, the accelerator 104 may include an electrostatic accelerator in which the particles are accelerated across a potential difference (or a series of such differences) and the voltage(s) may be varied to vary the speed of the particles. In another example, the accelerator 104 may include an electromagnetic accelerator in which the particles are accelerated through interaction with a time-varying electric field (e.g., a RF wave or laser) and the electric-field strength may be varied to vary the speed of the particle. In another example, the number of particle-field interactions in an electromagnetic accelerator may be varied to vary the speed of the particles. In another example, the magnetic-field generator may include an electromagnet and the electromagnet current may be varied to vary the magnetic-field strength.

In some implementations, the particle or magnetic-field direction may be varied to vary the direction of the force F. In some implementations, the number of particles from the source electrode 102 may be varied to vary the aggregate magnitude of the force F due to the individual particles.

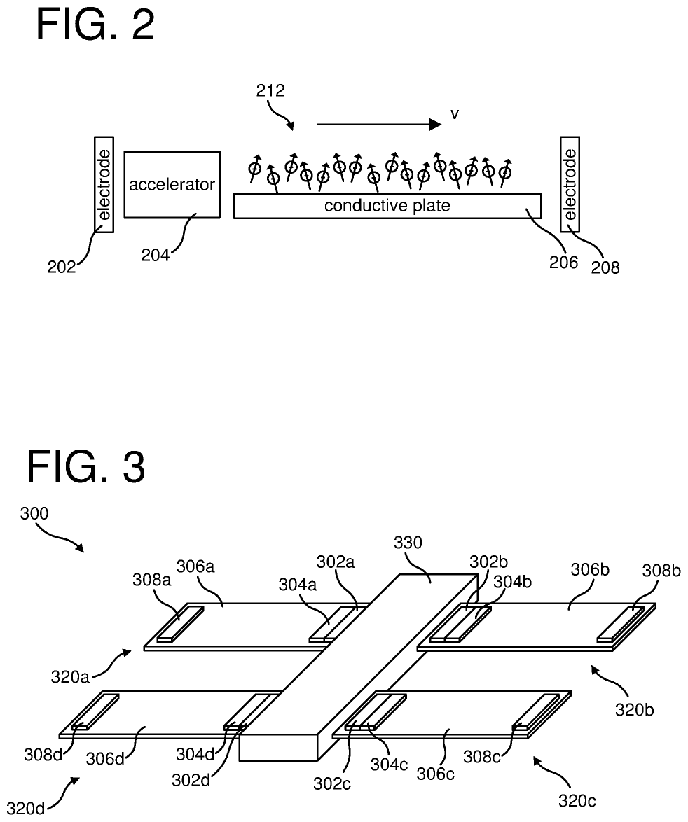

Another exemplary embodiment of an electromagnetic propulsion/levitation panel is represented in FIG. 2. In this embodiment, a source electrode 202 provides charged particles (electrons or ions) to an accelerator 204 that in turn accelerates the charged particles to a velocity (v). The accelerated particles 212 are directed to a sink electrode 208 along one or more paths adjacent to a conductive plate 206 (the paths are indicated by the arrows in the figures). The charged particles 212 in this embodiment have magnetic moments. In operation, there is an attractive force between the plate 206 and particles 212 flowing adjacent to the plate 206. This force includes a portion due to the polarization of the plate 206 induced by the charged particles 212 due to their charge and a portion due to eddy currents in the plate 206 induced by the charged particles 212 due to their magnetic moment and velocity. The eddy-current portion of the attractive force varies with the velocity of the particles 212.

An exemplary electromagnetically-driven vehicle 300 is depicted in FIG. 3. The vehicle 300 includes a chassis 330 to which four wings 320a, 320b, 320c, 320d are attached. Each wing 320a, 320b, 320c, 320d includes a source electrode 302a, 302b, 302c, 302d, a particle accelerator 304a, 304b, 304c, 304d, a magnetic-field generator 306a, 306b, 306c, 306d, and a sink electrode 308a, 308b, 308c, 308d. The control electronics and power source (not shown) may be included in the chassis or may be included in the wings 320a, 320b, 320c, 320d. In operation, charged particles are provided by the source electrodes 302a, 302b, 302c, 302d, are accelerated by the particle accelerators 304a, 304b, 304c, 304d, and travel to the sink electrodes 308a, 308b, 308c, 308d through magnetic fields generated by the magnetic-field generators 306a, 306b, 306c, 306d. As described with reference to FIGS. 1A-1C, this generates a force between the moving particles and the magnetic-field generators 306a, 306b, 306c, 306d and thus between the particles and the wings 320a, 320b, 320c, 320d. As the wings 320a, 320b, 320c, 320d are attached to the chassis 330, the entire vehicle 300 will experience the force due to the moving particles.

The force due to the moving particles can be used to, for example, counteract the force of gravity and cause the vehicle 300 to rise or levitate when the magnetic fields and particle velocities are appropriately oriented. More generally, the force can be used to propel the vehicle to move it in a direction determined by the magnetic fields and particle velocities. For example, the wings 320a, 320b, 320c, 320d may be pivotably attached to the chassis 330 to enable redirection of the magnetic field of one or more of the wings in order to steer and propel the vehicle 300. In another example, one or more of the magnetic-field generators 306a, 306b, 306c, 306d may include a steerable magnetic field (e.g., an electromagnet comprising multiple independent coils).

In an alternative embodiment, a vehicle may include a single source electrode and accelerator that provides a stream of charged particles to multiple magnetic-field generators.

In another alternative embodiment, a vehicle may include wings comprising conductive plates that interact with moving particles having magnetic moments, as described with reference to FIG. 2.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A vehicle comprising:
(a) a chassis;
(b) a charged-particle accelerator configured to accelerate a charged particle to a velocity v; and
(c) a magnetic-field generator attached to the chassis and configured to generate a magnetic field B;
(d) wherein the charged-particle accelerator is positioned relative to the magnetic-field generator so that a charged particle accelerated to velocity v by the charged-particle accelerator passes through a magnetic field B generated by the magnetic field generator; and
(e) wherein the velocity v and the generated magnetic field B have a non-zero cross product (v×B≠0).

2. The vehicle of claim 1 wherein the charged-particle accelerator includes an electromagnetic accelerator comprising an infrared laser.

3. The vehicle of claim 1 wherein the charged-particle accelerator includes an electromagnetic accelerator comprising an ultraviolet laser.

4. The vehicle of claim 1 wherein the charged-particle accelerator includes an electromagnetic accelerator comprising an x-ray laser.

5. The vehicle of claim 1 wherein the charged-particle accelerator includes an electrostatic accelerator.

6. The vehicle of claim 1 wherein the magnetic-field generator includes a permanent magnet.

7. The vehicle of claim 1 wherein the magnetic-field generator includes an electromagnet.

8. The vehicle of claim 7 wherein the electromagnet includes multiple independent coils.

9. The vehicle of claim 1 wherein the magnetic-field generator is pivotably attached to the chassis.

10. An electromagnetic propulsion system comprising:
(a) a chassis;
(b) a magnetic-field generator attached to the chassis and configured to generate a magnetic field; and
(c) a means for providing a stream of charged particles adjacent to the magnetic-field generator such that the particles of the stream of charged particles are directed, on average, other than parallel or antiparallel to the magnetic field.

11. The electromagnetic propulsion system of claim 10 wherein the magnetic-field generator includes multiple independent coils.

12. The electromagnetic propulsion system of claim 10 wherein the means for providing a stream of charged particles includes at least one of the group consisting of an infrared laser, an ultraviolet laser, and an x-ray laser.

13. A method of providing a force to a vehicle comprising a chassis and a magnetic-field generator attached to the chassis, the method comprising:
(a) generating a magnetic field using the magnetic-field generator;
(b) accelerating a stream of charged particles;
(c) directing the stream of accelerated charged particles through the magnetic field such that the direction of the stream is not parallel or antiparallel to the direction of the magnetic field.

14. The method of claim 13 wherein generating a magnetic field using the magnetic-field generator includes providing one or more electrical currents to one or more coils.

15. The method of claim 13 wherein the magnetic-field generator includes a permanent magnet and generating a magnetic field using the magnetic-field generator includes providing the magnetic field of the permanent magnet.

16. The method of claim 13 wherein accelerating a stream of charged particles includes exposing the charged particles to a laser beam.

17. The method of claim 16 wherein the laser beam is one of the group consisting of an infrared laser beam, an ultraviolet laser beam, and a x-ray laser beam.

18. The method of claim 13 further comprising pivoting the magnetic field generator relative to the chassis to change the direction of the generated magnetic field relative to the chassis.

19. The method of claim 13 further comprising changing at least one of the group consisting of the direction of the magnetic field and the magnitude of the magnetic field.

20. The method of claim 13 further comprising changing at least one of the group consisting of the direction of the stream of particles and the average of the speeds of the particles of the stream of particles.
